(19) United States
(12) Patent Application Publication
(10) Pub. No.: US 2022/0151171 A1
(43) Pub. Date: May 19, 2022

(54) GARDEN SYSTEM

(71) Applicant: Douglas J. Behrendt, Venice, FL (US)

(72) Inventor: Douglas J. Behrendt, Venice, FL (US)

(21) Appl. No.: 16/952,427

(22) Filed: Nov. 19, 2020

(51) Int. Cl. A01G 27/00; A01G 7/04; A01G 9/28

(52) U.S. Cl. CPC A01G 27/005; A01G 9/28; A01G 7/045; A01G 27/008

(57) ABSTRACT

A garden system that include a garden box having at four walls and a floor. The walls and the floor form a plant receiving area. The each wall includes an internal cavity that holds water and acts together as a water tank. The water tank has an input and an output. The garden system also includes a watering system connected to the water tank and is positioned to provide water to the plant receiving area.

### BACKGROUND

The present invention generally relates to horticulture. More specifically, the present invention relates to garden boxes that can be used indoor or outdoor.

Organic herb gardens are rising in popularity along with multi-use gardening from vegetables, herbs, plants, fruits and even for medically licensed growers. Today, more often is the case that commercially available vegetables are tainted with bacteria that cause consumer to take ill and even causes death. Consumers are turning to raising their own vegetables to avoid tainted vegetables. Most consumers have limited space or no land to grow plants and vegetables. Therefore, consumers are using garden boxes inside and outside their homes. An issue with using a garden box is keeping a garden watered manually is difficult if the consumer is away on vacation or business.

It is an object of the present invention to provide a programmable self-watering garden system.

### SUMMARY

A garden system that include a garden box having at four walls and a floor. The walls and the floor form a plant receiving area. The each wall includes an internal cavity that holds water and acts together as a water tank. The water tank has an input and an output. The garden system also includes a watering system connected to the water tank and is positioned to provide water to the plant receiving area.

### BRIEF DESCRIPTION OF DRAWINGS

FIG. 1 is a perspective view of a garden system according to the present invention.

FIG. 2 is a perspective view of a garden according to the present invention.

FIG. 3 is a cross sectional view of a garden according to the present invention.

FIG. 4 is a top view of a garden according to the present invention.

FIG. 5 is a perspective view of a garden according to the present invention.

FIG. 6 is a perspective view of a garden according to the present invention.

FIG. 7 is a perspective view of a garden according to the present invention.

FIG. 8 is a perspective view of a garden according to the present invention.

FIG. 9 is a perspective view of a garden according to the present invention.

FIG. 10 is a perspective view of a garden according to the present invention.

### DETAILED DESCRIPTION

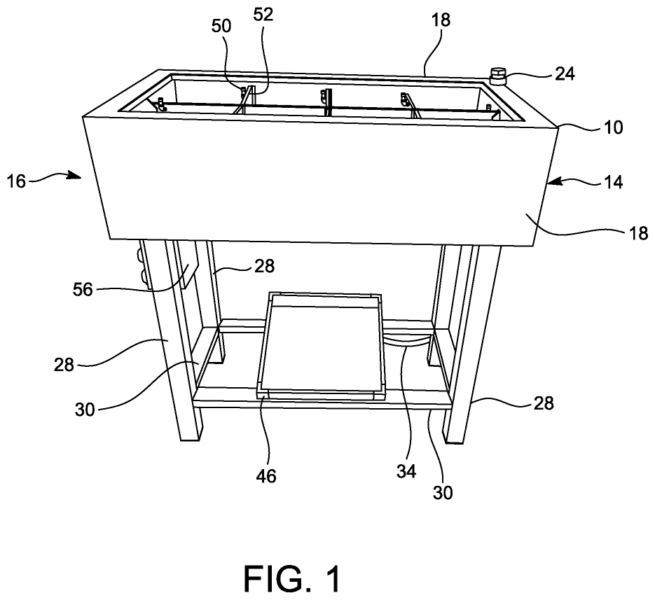

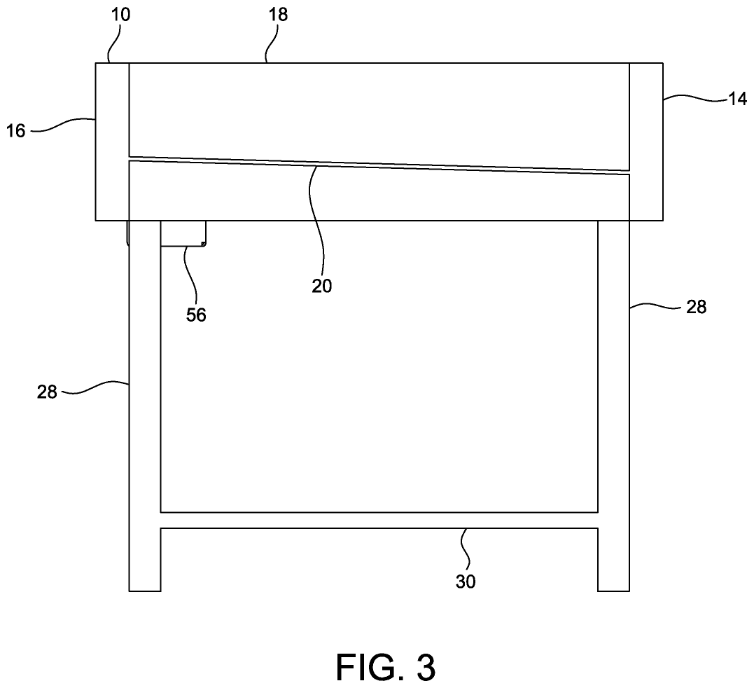

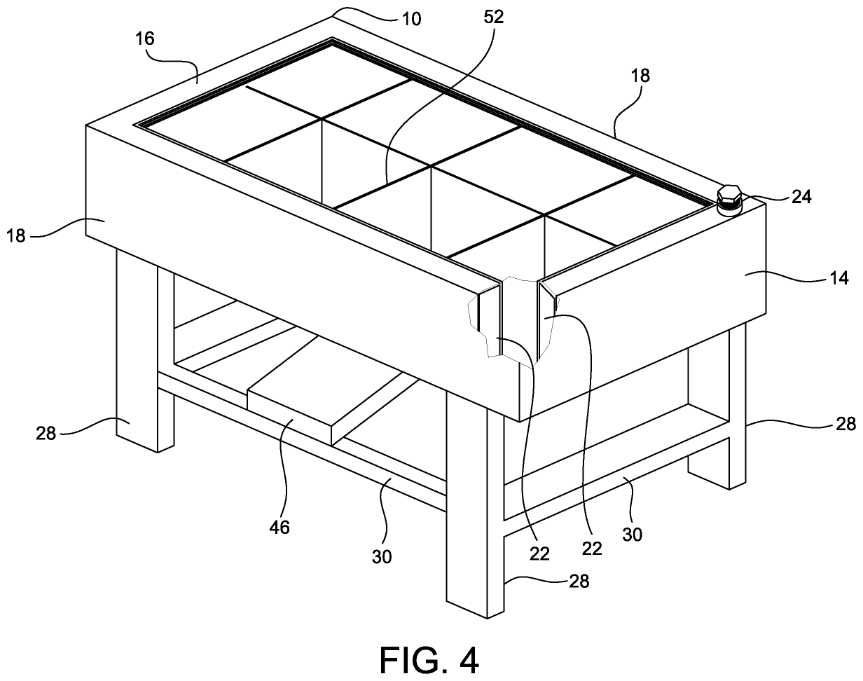

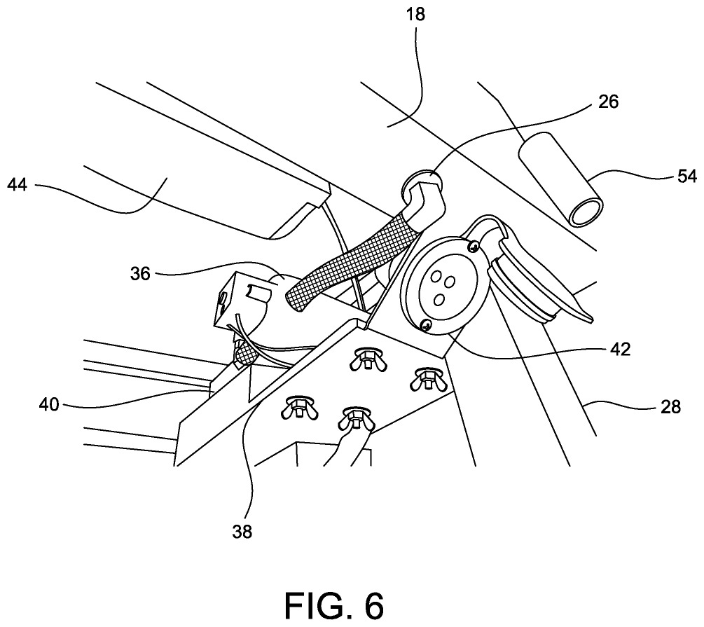

The present invention is garden system that includes a garden box 10, support legs 28 and programmable watering system. FIGS. 1-4 show the garden box 10. The garden box 10 is shown as a rectangular shape that includes a first end wall 14, a second end wall 16, two side walls 18 and a floor 20. A standard size garden box 10 is 36″ long (L)×20″ wide (W) outside dimensions. The end walls 14, 16 and side walls 18 surround the floor 20 to form a plant receiving area. It is envisioned that the walls of the garden box 10 could be any shape, such as a continuous round wall in the shape of a cylinder about the floor to form the plant receiving area. The end walls 14, 16 and side walls 18 have a thickness as well as a height and width dimension. An example of the size of the end walls 14, 16 is twenty inches in length, ten inches in height and two inches wide; and the size of the side walls is thirty-six inches in length, ten inches in height and two inches wide. Each wall 14, 16, 18 has an internal cavity 22, as shown in FIG. 4. The internal cavities 22 of each wall 14, 16, 18 are interconnected to form a water tank in the walls 14, 16, 18 that is hermetically sealed. Therefore the water tank acts as the walls of the garden box 10. With the dimensions disclosed, the water tank can hold approximately seven gallons of water. The seven gallons of water will water the plant receiving area of that size on a schedule of once per day for approx. 28 days before refilling is needed. The water tank includes 1½″ filling bung on the top of the first end wall 14 that includes a vented cap 24 for filling the water tank. The bottom of the water tank on one of the side walls 18 includes a ⅝ delivery bung 26 that feeds the water to the watering system, as shown in FIG. 6. The plant receiving area has inside dimensions about 32″ long×16″ wide with the garden depth of 5″ on the second end sloping to 6″ on the first end wall, providing a 1″ drop is for draining purposes as shown in FIG. 3.

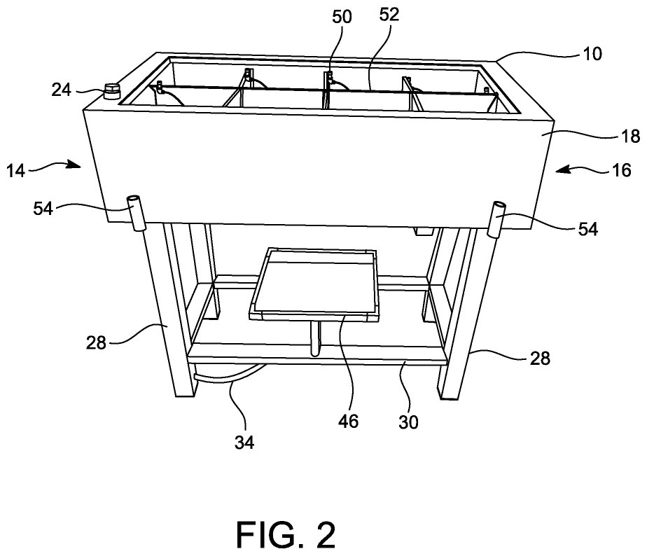

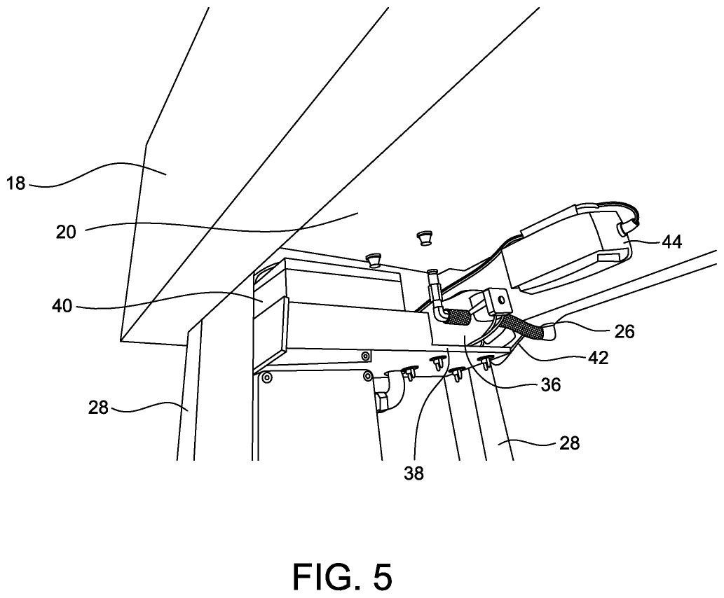

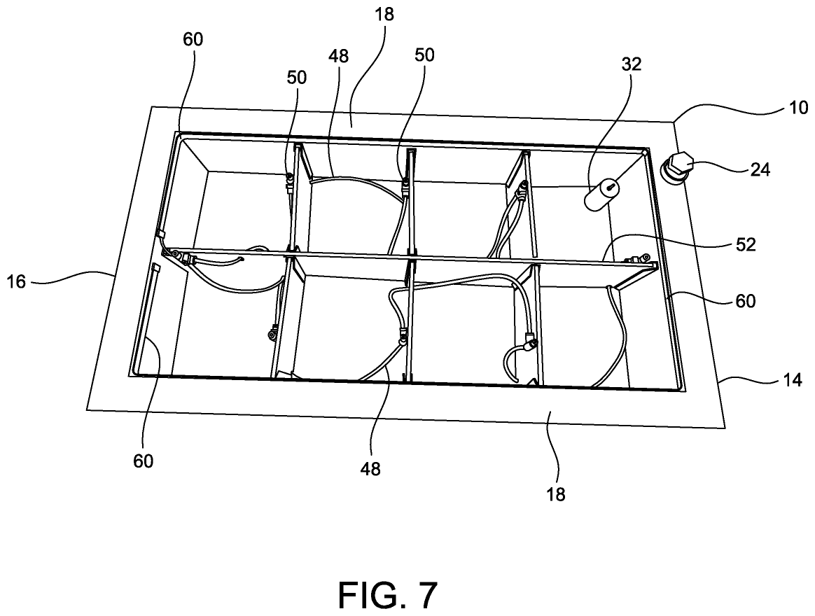

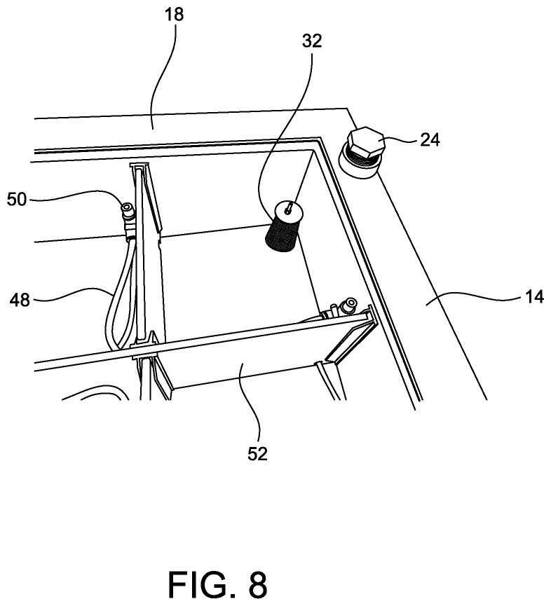

The garden system includes four legs 28 that extend down from the walls 14, 16, 18 to support the garden system on a surface. The legs 28 are typically two inch by two inch and hollow. The legs 28 include leg cross members 30 that interconnect the legs 28. FIG. 3 is a cut away drawing showing the floor 20 of the garden box 10. The floor 20 is shown sloping to the second end wall 16 to the first end wall 14 for water drainage. The drain 32 is shown in FIGS. 7-8 with a cone style stainless steel filter screwed on as part of the drain 32 to prevent dirt from escaping through the drain 32. The drain 32 aligns with one of the legs and is ½ inch bung used in the floor. The drain 32 is connected to a hose 34 shown in FIG. 2 that runs inside of the leg 28 and exits out the bottom of that leg 28. The drain 32 is used to drain the garden box 10 if there is too much water from rain. A 12v water pump 36 is mounted on a tray 38 that is mounted underneath the floor 20, as shown in FIGS. 5-6. The water pump 36 is connected to the delivery bung 26. The tray 38 also supports a dry cell 12v 12 amp hour battery 40 and an AC electrical socket 42. There is also a battery charger 44 mounted under the floor 20 that is connected to the battery 40 and the socket 42. The electrical socket 42 includes a weather proof cap. A solar panel 46 is interconnected to the battery 40 and battery charger 44. The solar panel 46 is mounted on the cross members 30 at a slight angle to capture the sun and charge the battery 40.

The garden system includes a misting system that runs throughout the plant receiving area inside of the garden box 10, as shown in FIGS. 7-8. The misting system includes misting tubes 48 connected to misting heads 50. The misting tubes 48 are connected to the water pump 36 and daisy chained together. The plant receiving area is shown with dividers 52 that are removable. The dividers 52 separate the garden into 8-8″×8″ sections. Each section has a mister head 50 mounted on the dividers 52. The angles for the mister head 50 are adjustable. The portion of the floor 20 within each divider 52 can be lined with a thin layer of pea rocks ½″ thick on the bottom and then ¼ Coconut Liner Sheet 8″×8″ that sit on the pea rocks to retain moisture and dirt. Organic dirt can then be placed over the coconut liner. The mister heads 50 are pushed in and easily removable from the mister tubes 48 for cleaning or changing out. There are indoor mister systems, as well as outdoor mister systems that can be used. A top that is adjustable and removable can be attached to the two top support receivers 54 of 1″ tubing mounted on the back of the garden box, as shown in FIG. 2.

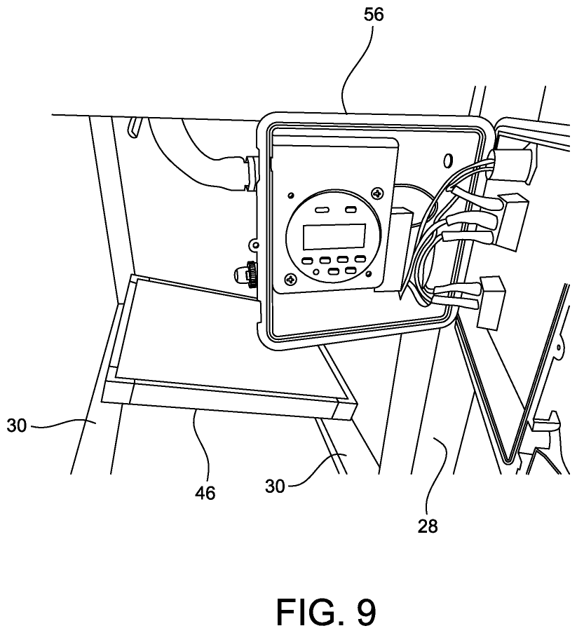

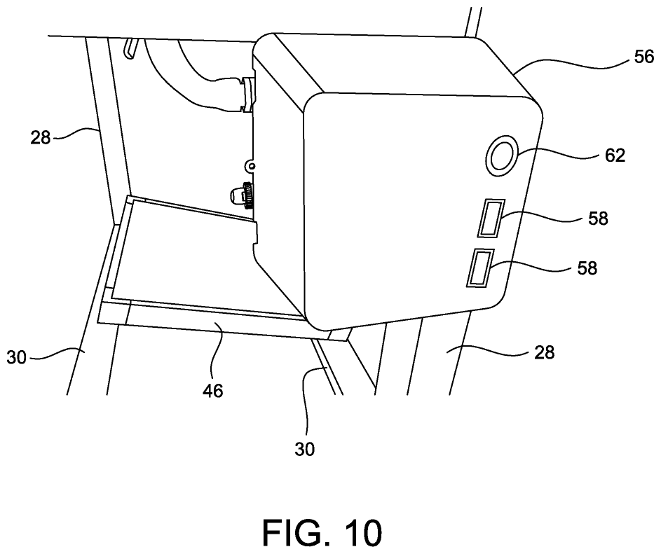

There is a small electrical box 56 mounted to the framework of the garden box 10, as shown in FIGS. 9-10. The electrical box 56 includes a 12 Volt system connected to the battery 40 with a timer system inside that has 16 independent ON/OFF schedules that a user can set to water plants, 1 minute to 7 days timing range. The timer system turns the water pump 36 on and off. There are 2 marine toggle switches 58 on the outside of the electrical box 56. One switch 58 in the down position will manually fire off the mister heads 50. The up position strictly uses the timer mode programmed by the user to turn on the mister heads 50 per the set program. The second switch 58 connected to a marine led light strip 60. The light strip 60 runs along the top edge of the inside diameter of the garden box 10, as shown in FIG. 7. There is a dimming switch 62 mounted on the outside of the electrical box 56 to dim the lights 60.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A garden system, comprising:
a garden box having at least one wall and a floor, wherein said wall and said floor form a plant receiving area;
said at least one wall includes an internal cavity that holds water and acts as a water tank, said water tank having an input and an output;
a watering system connected to said water tank and is positioned to provide water to said plant receiving area.

2. The garden system of claim 1, wherein said at least one wall including a first end wall, a second end wall, a first side wall and a second side wall, wherein said first side wall interconnecting said first end wall and said second end wall, said second side wall interconnecting said first end wall and said second end wall, whereby said first end wall, said second end wall, said first side wall and said second side wall forms a rectangular box that define said plant receiving area and wherein said internal cavities of each wall are interconnected to form one water tank.

3. The garden system of claim 1, wherein said floor slopes within said plant receiving area to allow water to drain in one direction.

4. The garden system of claim 1, wherein said floor includes a drain and a filter to drain excess water.

5. The garden system of claim 1, further including dividers in said plant receiving area.

6. The garden system of claim 1, further including legs extending downward to contact a surface to support said garden box above said surface.

7. The garden system of claim 1, wherein said watering system includes a pump connected to said water tank and a misting system connected to said pump.

8. The garden system of claim 7, wherein said pump is mounted to said garden box.

9. The garden system of claim 7, further including a battery connected to said pump and a timer system connected between said battery and said pump.

10. The garden system of claim 1, further including lights about said garden box.
